(19) United States
(12) Patent Application Publication
(10) Pub. No.: US 2011/0074334 A1
(43) Pub. Date: Mar. 31, 2011

(54) POWER-SAVING SOLAR POWER SUPPLY SYSTEM FOR AUTOMATIC VENDING MACHINE

(76) Inventors: Ku-Fang WANG, Taipei City (TW); Chih-Hao HSU, Taipei City (TW); Tien-Yuan CHIEN, Taipei City (TW); Wei CHIU, Taipei City (TW)

(21) Appl. No.: 12/567,368

(22) Filed: Sep. 25, 2009

(51) Int. Cl. H01M 10/46; G07F 11/00; H02N 6/00

(52) U.S. Cl. 320/101; 221/199; 136/244

(57) ABSTRACT

A power-saving solar power supply system used in an automatic vending machine is disclosed to include a power supply module having a solar cell set and a rechargeable battery set, and a power management unit, which comprises a microprocessor, a voltage detection device that detects the voltage level of the solar cell set and the rechargeable battery set, an idle power supply module and a power switching module controllable by the microprocessor to switch between the solar cell set and the rechargeable battery set so that the idle power supply module provides battery power supply from the solar cell set or the rechargeable battery set to the recognition system of the automatic vending machine when the recognition system is in the idle mode, thereby saving power consumption.

### BACKGROUND OF THE INVENTION

1. Field of the Invention

The present invention relates to a power supply system for an automatic vending machine and more particularly, to a power-saving solar power supply system for automatic vending machine, which provides the necessary working power to the recognition system of the automatic vending machine when the recognition system is in the idle mode so that the automatic vending machine does not need to start up its power supply system during the idle mode, saving power consumption.

2. Description of the Related Art

Following fast progress of social civilization and fast development of modern technology, the pace of life has been accelerating, and people in city are busy. In consequence, automatic vending machines are intensively used and installed in public places to sell different products or to provide different services, bringing convenience to people and saving much the labor cost.

Regular automatic vending machines are used to sell different products 24 hours a day without serviceman. These automatic vending machines are highly invited for the advantage of saving much labor and bringing convenience to people. However, an automatic vending machine consumes much power supply when started up. To save power consumption, an automatic vending machine may provide an idle mode. An automatic vending machine with a power-saving idle mode reduces the consumption of power of its motor drive and recognition system. Normally, an automatic vending machine with a power-saving idle mode can save power consumption about 34%. Many countries have established regulations to rule power consumption. European Union defines a EuP's ecological profile that consists of the measurable physical inputs and outputs (such as materials, emissions and waste) over the product's entire life cycle. The EuP directive provides the legislative criteria and framework for the move to life cycle ecodesign.

There are automatic vending machine providers install a power management unit in each automatic vending machine they provide. The power management unit provides power management or switches the automatic vending machine to an idle mode or off mode when the main function of the automatic vending machine is not started or the recognition system of the automatic vending machine does to provide its service, thereby saving power consumption. During the idle mode, the power consumption is below 0.5 W. The internal rechargeable battery of the automatic vending machine can satisfy the power consumption when the recognition system is in the idle mode. However, the power of a battery used in an automatic vending machine will be used up within a certain length of time. The automatic vending machine business operator must send people to check the power level of the battery of each installed automatic vending machine regularly and to replace the battery of which the power is low. This automatic vending machine business operating manner greatly increases the labor cost.

Therefore, it is desirable to provide a green power supply system that is practical for use in any of a variety of existing automatic vending machines, saving the consumption of power.

### SUMMARY OF THE INVENTION

The present invention has been accomplished under the circumstances in view. It is therefore the main object of the present invention to provide a power-saving solar power supply system for automatic vending machine, which saves power consumption and assures normal functioning of the automatic vending machine.

To achieve this and other objects of the present invention, a power-saving solar power supply system for automatic vending machine comprises a power supply module having a solar cell set and a rechargeable battery set, and a power management unit. The power management unit comprises a microprocessor, a voltage detection device controllable by the microprocessor to detect the voltage level of the solar cell set and the rechargeable battery set, a power switching module controllable by the microprocessor to alternatively switch between the solar cell set and the rechargeable battery set subject to the detection result of the voltage detection device, an idle power supply module electrically connected to the recognition system of the automatic vending machine and controllable by the microprocessor through the power switching module to provide battery power supply from one the solar cell set and the rechargeable battery set to the recognition system subject to the detection result of the voltage detection device, a sleep/wakeup switch controllable by the microprocessor to switch the idle power supply module between a sleep mode and a wakeup mode, and a charging control module controllable by the microprocessor to charge the rechargeable battery set with the solar cell set.

### BRIEF DESCRIPTION OF THE DRAWINGS

FIG. 1 is a system block diagram of a power-saving solar power supply system for automatic vending machine in accordance with the present invention.

FIG. 2 is a sleep/wakeup operation flow chart of the present invention.

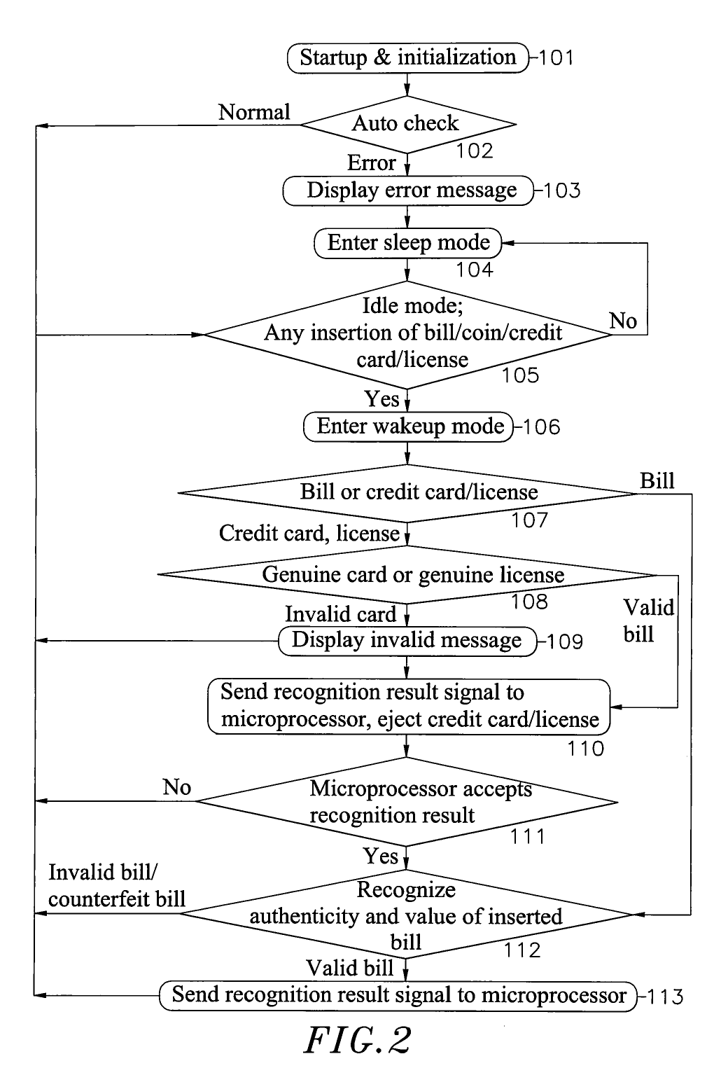

FIG. 3 is a power switching flow chart of the present invention.

FIG. 4 is schematic drawing showing the outer appearance of an automatic vending machine equipped with a power-saving solar power supply system in accordance with the present invention.

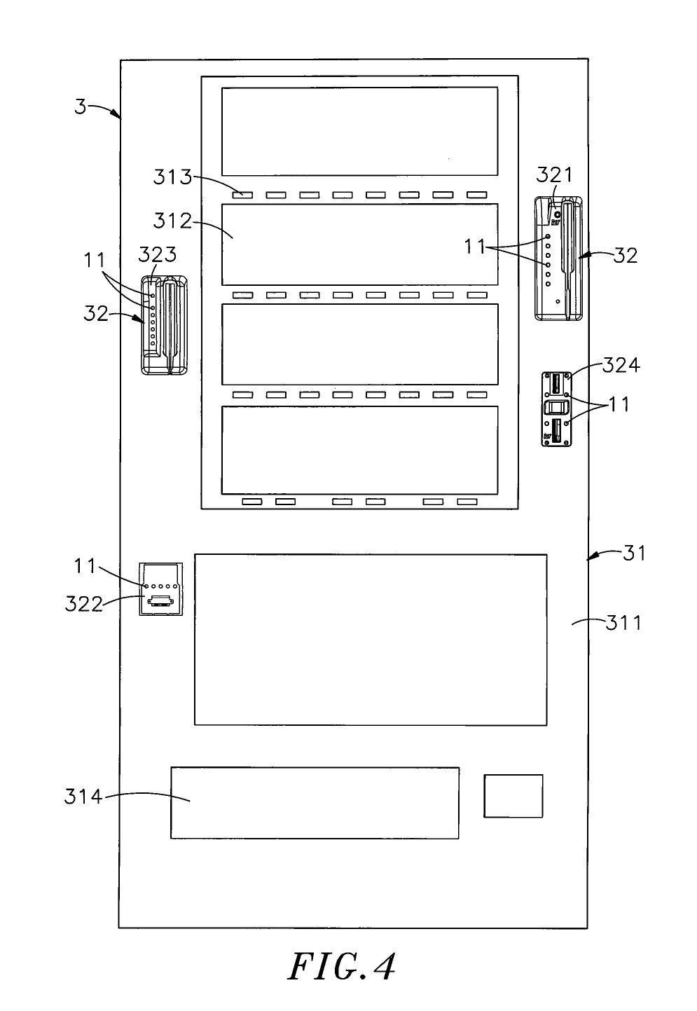

### DETAILED DESCRIPTION OF THE PREFERRED EMBODIMENT

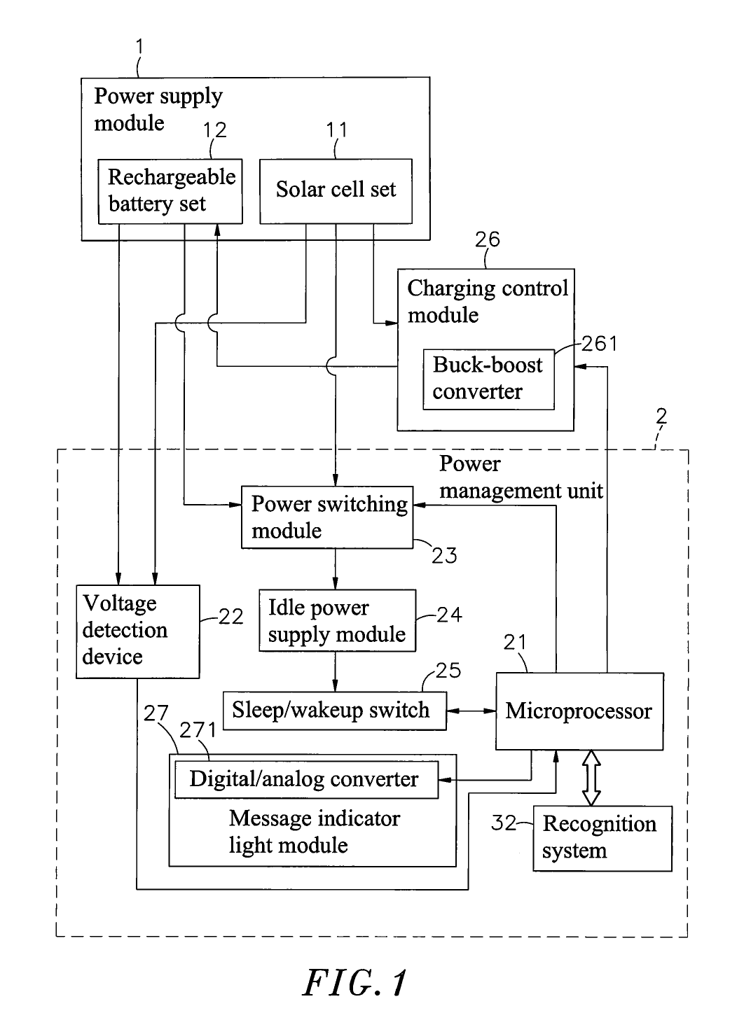

Referring to FIGS. 1˜4, a power-saving solar power supply system for automatic vending machine in accordance with the present invention is shown installed in an automatic vending machine 3, comprising a power supply module 1 and a power management unit 2.

The power supply module 1 comprises a solar cell set 11 and a rechargeable battery set 12. The solar cell set 11 comprises a plurality of solar cells arranged in an array. The solar cells can be solar cell lamps or solar cell SMDs (Surface Mounted Devices). One single piece of solar cell lamp provides 0.95V, 4 mA. One single piece of solar cell SMD provides 0.95V, 10 mA.

The power management unit 2 comprises a microprocessor 21, a voltage detection device 22 electrically connected to the microprocessor 21 and adapted to detect the voltage of the solar cell set 11 and the rechargeable battery set 12, a power switching module 23, which is electrically connected to the solar cell set 11 and the rechargeable battery set 12 and controllable by the microprocessor 21 to alternatively switch between the solar cell set 11 and the rechargeable battery set 12, an idle power supply module 24, which is electrically connected to the recognition system 32 of the automatic vending machine 3 and controllable by the microprocessor 21 through the power switching module 23 to provide battery power supply from the solar cell set 11 or the rechargeable battery set 12 to the recognition system 32 of the automatic vending machine 3, a sleep/wakeup switch 25 electrically connected to the idle power supply module 24 and controllable by the microprocessor 21 to switch the idle power supply module 24 between a sleep mode and a wakeup mode, a charging control module 26, which comprises a buck-boost converter 261 electrically connected in series between the solar cell set 11 and the rechargeable battery set 12 and controllable by the microprocessor 21 to raise or lower the voltage of the output power of the solar cell set 11 for charging the rechargeable battery set 12, and a message indicator light module 27 that comprises a digital/analog converter 271 electrically connected to the microprocessor 21 and controllable by the microprocessor 21 to provide different visual indications.

The automatic vending machine 3 comprises a housing 31 and a recognition system 32 mounted in the housing 31 and electrically connected to the microprocessor 21 of the power management unit 2. The housing 31 has a motor drive (not shown) mounted therein, a face panel 311 located on the front side, multiple merchandise exhibition compartments 312 defined in the face panel 311 at different elevations, a plurality of buttons 313 arranged on the face panel 311 corresponding to the merchandise exhibition compartments 312, and a merchandise takeout outlet 314 formed in the face panel 311 near the bottom side. The recognition system 32 comprises a card-sliding unit 321, a bill acceptor 322, a license recognition unit 323 and a coin slot unit 324 respectively exposed to the outside of the face panel 311. When a user wishes to purchase merchandise from the automatic vending machine 3, the user must insert a license into the card-sliding unit 321 or the license recognition unit 323 for recognition. The user can insert a bill into the bill acceptor 322 or a coin into the coin slot unit 324 only after his (her) license has been recognized and approved. After receipt of a bill or coin, the microprocessor 21 drives the motor drive in the housing 31 to dispense the selected age-controlled merchandise to the merchandise takeout outlet 314, finishing the transaction. Thus, the automatic vending machine 3 can sell controlled merchandise and can prohibit unqualified people to purchase controlled merchandise.

When starting up the recognition function, the system runs subject to the following steps:
(101) Start up initialization;
(102) Run auto check, and then proceed to step (103) when error, or step (105) when normal;
(103) Display error message;
(104) Enter sleep mode;
(105) Enter idle mode and simultaneously detect any insertion of a bill, coin, credit card or license within a predetermined time period, and then repeat step (104) when negative, or proceed to step (106) when positive;
(106) Enter wakeup mode;
(107) Determine whether a bill or a credit card/license is inserted, and then proceed to step (108) when a credit card/license is inserted, or step (112) when a bill is inserted;
(108) Recognize the inserted credit card/license is a genuine card or license, and then proceed to step (109) if the credit card/license is a counterfeit card or counterfeit license, or step (110) if the credit card/license is a genuine card or genuine license;
(109) Display the message of invalid card/license, and then return to step (105);
(110) Provide a recognition result signal to the microprocessor 21 and eject the inserted credit card/license;
(111) Wait for instruction from the microprocessor 21 whether or not to accept the recognition result, and then return to step (105) when negative, or proceed to step (112) when positive;
(112) Recognize the authenticity and face value of the inserted bill, and then return to step (105) if the inserted bill is a counterfeit, or proceed to step (113) if the bill is a genuine bill;
(113) Send a recognition result signal to the microprocessor 21 and then return to step (105).

As stated above, after startup of the automatic vending machine 3, the microprocessor 21 runs initialization to set firmware parameters and to check any error automatically. When an error is found, the microprocessor 21 controls the message indicator light module 27 to give a corresponding visual indication by means of turning on a corresponding color light or flashing one light subject to a predetermined frequency. At the same time, the microprocessor 21 controls the sleep/wakeup switch 25 to switch the recognition system 32 to the sleep mode. When normal, the recognition system 32 enters the idle mode, and the microprocessor 21 controls the power switching module 23 to switch to the solar cell set 11 or the rechargeable battery set 12 subject to voltage detection result and to further provide power supply to the recognition system 32 via the idle power supply module 24. During the idle mode, the recognition system 32 detects any insertion of a bill, coin, credit card or license within a predetermined time period, and then enters the sleep mode after a predetermined time period when no any insertion is detected. When an insertion is detected, the user must insert a credit card or license into the card-sliding unit 321 or the license recognition unit 323 at first. After the inserted credit card or license has passed the verification and has been rejected, it is necessary to wait for the decision of the microprocessor 21 whether or not to accept the recognition result. When the microprocessor 21 accepts the recognition result, the automatic vending machine 3 immediately enters the wakeup mode, thereby turning on the power supply for the bill acceptor 322 and the coin slot unit 324 for the insertion of a bill or coin. When a bill is inserted into the bill acceptor 322, the bill acceptor recognizes the authenticity and value of the inserted bill. If the inserted bill or coin is a counterfeit, the microprocessor 21 controls the message indicator light module 27 to give a visual signal indicative of an invalid message and then drives the recognition system 32 into the sleep mode. Therefore, when the automatic vending machine 3 is in the idle mode, the power supply is not started up to run merchandise selling operation. At this time, the idle power supply module 24 provides the necessary working voltage to the recognition system 32 to scan any insertion of a bill, coin, credit card or license. By means of the solar cell set 11 or rechargeable battery set 1 of the solar cell power supply module 1, the recognition system 32 can obtain sufficient power supply required during its idle mode, saving power consumption for the motor drive, lighting fixture and peripheral devices of the recognition system 32. Therefore, the invention effectively saves power consumption, and reduces management cost.

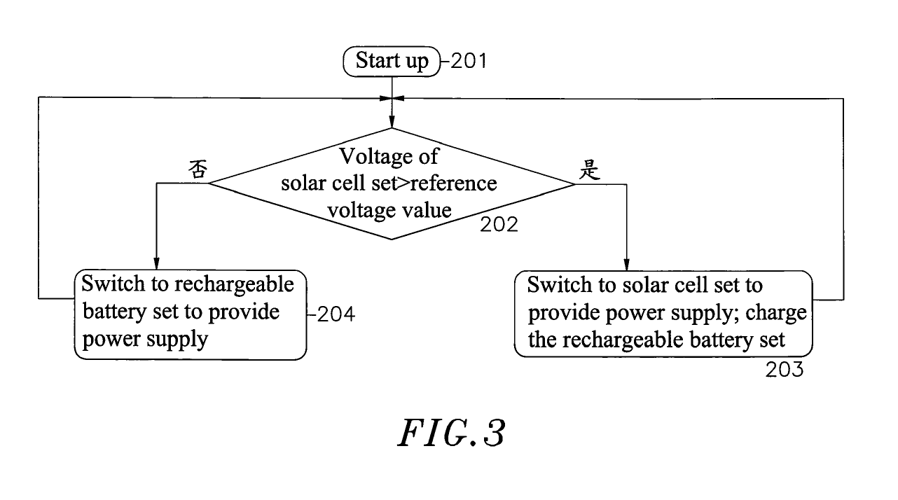

Further, when entering the idle mode, the power supply switching operation runs subject to the following steps (as shown in FIG. 3):
(201) Start up;
(202) Detect whether or not the voltage of the solar cell set 11 is over a predetermined reference voltage value? And then proceed to step (203) when over the predetermined reference voltage value, or step (204) when below the predetermined reference voltage value;
(203) Switch to the solar cell set 11 to obtain the necessary working voltage from the solar cell set 11 to let the rechargeable battery set 12 to be charged with the power supply from the solar cell set 11, and then return to step (202);
(204) Switch to the rechargeable battery set 12 to obtain the necessary working voltage from the rechargeable battery set 12, and then return to step (202).

It is to be understood that when the power supply module 1 and the power management unit 2 are started up, the voltage detection device 22 detects the voltage level of the solar cell set 11 and compared the detected voltage to a predetermined reference voltage value. The microprocessor 21 decides whether or nor to let the solar cell set 11 output its power supply subject to the detection result from the voltage detection device 22. If the voltage of the solar cell set 11 surpasses the predetermined reference voltage value, the microprocessor 21 gives a signal to the power switching module 23, causing the power switching module 23 to switch on the connection between the solar cell set 11 and the idle power supply module 24 and to simultaneously switch off the connection between the rechargeable battery set 12 and the idle power supply module 24, enabling the power supply to be supplied from the solar cell set 11 to the sleep/wakeup switch 25, the microprocessor 21 and the recognition system 32 of the automatic vending machine 3. At this time, the microprocessor 21 gives a signal to the charging control module 26, causing the charging control module 26 to charge the rechargeable battery set 12 with the solar cell set 11. If the voltage of the solar cell set 11 is below the predetermined reference voltage value, the power switching module 23 switches off the connection between the solar cell set 11 and the idle power supply module 24 and simultaneously switch on the connection between the rechargeable battery set 12 and the idle power supply module 24, enabling the power supply to be supplied from the rechargeable battery set 12 to the sleep/wakeup switch 25, the microprocessor 21 and the recognition system 32 of the automatic vending machine 3. Further, it the vending machine 3 has a rechargeable power supply unit set therein, the aforesaid rechargeable battery set can be eliminated. In this case, the rechargeable power supply unit of the automatic vending machine 3 is electrically connected to the power switching module 23 and voltage detection device 22 of the power management unit 2, i.e., the rechargeable power supply unit of the automatic vending machine 3 is used to substitute for the aforesaid rechargeable battery set 12 such that the rechargeable power supply unit of the automatic vending machine 3 and the solar cell set 11 can be alternatively selected to provide the recognition system 32 with the necessary working voltage. Further, during normal working of the power supply module 1 or when the detected battery voltage is below the predetermined reference voltage value, the microprocessor 21 receives a detection result signal from the voltage detection device 22 and then controls the message indicator light module 27 to give a corresponding visual indication signal, indicating the message of “normal” or “voltage low”.

It is to be understood that the above disclosure simply explains an example of the present invention but not intended as a limitation of the spirit of the scope of the invention. The rated voltage of the solar cell set 11 and the rechargeable battery set 12 can be 2.8V, 3.4V, 3.8V or the like. Further, the rated voltage can be changed subject to actual requirements. The voltage range of the solar cell set 11 detectable by the voltage detection device 22 can be within 2.7V˜3.6V. Preferably, the rated voltage can be 3.8V, and the reference voltage value can be 3.6V. When the voltage of the solar cell set 11 is below 3.6V, the solar cell set 11 is stopped from outputting power supply, and the rechargeable battery set 12 is switched on to output power supply. Further, the solar cell set 11 can be comprised of an array of solar cell lamps or solar cell SMDs (Surface Mounted Devices) arranged inside the housing 31 of the automatic vending machine 3 or on the outside of the recognition system 32. Further, the face panel 311 can be wholly or partially made from transparent or translucent glass or acrylic so that the solar cell set 12 can be radiated by sunlight and convert solar energy into electricity for charging the rechargeable battery set 12 or supplying to the recognition system 32 during the idle mode subject to the control of the power switching module 23, thereby assuring continuous detection and normal working of the microprocessor 21 and avoiding the automatic vending machine to start up the power supply for merchandise selling operation. Therefore, the invention greatly saves power consumption during the idle mode.

A prototype of power-saving solar power supply system for automatic vending machine has been constructed with the features of FIGS. 1˜4. The power-saving solar power supply system for automatic vending machine functions smoothly to provide all of the features disclosed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A power-saving solar power supply system used in an automatic vending machine having a recognition system for verifying a bill, coin, credit card or license inserted by a user into said automatic vending machine, comprising:
a power supply module, said power supply module comprising a solar cell set and a rechargeable battery set, said solar cell set comprising a plurality of solar cells mounted in said automatic vending machine for receiving sunlight and converting sunlight into electricity; and
a power management unit, said power management unit comprising a microprocessor, a voltage detection device controllable by said microprocessor to detect the voltage level of said solar cell set and said rechargeable battery set, a power switching module controllable by said microprocessor to alternatively switch between said solar cell set and said rechargeable battery set subject to the detection result of said voltage detection device, an idle power supply module electrically connected to said recognition system of said automatic vending machine and controllable by said microprocessor through said power switching module to provide battery power supply from one of said solar cell set and said rechargeable battery set to said recognition system, a sleep/wakeup switch controllable by said microprocessor to switch said idle power supply module between a sleep mode and a wakeup mode, and a charging control module controllable by said microprocessor to charge said rechargeable battery set with said solar cell set.

2. The power-saving solar power supply system as claimed in claim 1, wherein said solar cell set is mounted in said automatic vending machine behind a light penetrable face panel of said automatic vending machine outside said recognition system and controllable by said microprocessor to charge said rechargeable battery set and to provide the necessary working power supply to said recognition system when said recognition system is in the idle mode.

3. The power-saving solar power supply system as claimed in claim 1, wherein said solar cell set is comprised of an array of solar cell lamps.

4. The power-saving solar power supply system as claimed in claim 3, wherein, each said solar cell lamp provides electricity of 0.9V and 4 mA.

5. The power-saving solar power supply system as claimed in claim 1, wherein said solar cell set is comprised of an array of solar cell SMDs (Surface Mounted Devices),

6. The power-saving solar power supply system as claimed in claim 5, wherein each said solar cell SMD provides electricity of 0.95V and 10 mA.

7. The power-saving solar power supply system as claimed in claim 1, wherein said rechargeable battery set is a plurality of internal storage battery power supply unit of said automatic vending machine.

8. The power-saving solar power supply system as claimed in claim 1, wherein said charging control module comprises a buck-boost converter electrically connected in series between said solar cell set and said rechargeable battery set and controllable by said microprocessor to raise/lower the voltage of the output power of said solar cell set for charging said rechargeable battery set.

9. The power-saving solar power supply system as claimed in claim 1, wherein said power management unit further comprises a message indicator light module, said message indicator light module comprising a digital/analog converter electrically connected to said microprocessor and controllable by said microprocessor to provide one of a normal visual indication and a low voltage visual indication.

10. The power-saving solar power supply system as claimed in claim 1, wherein said voltage detection device detects the voltage level of said solar cell set and outputs a signal indicative of the detection result to said microprocessor; said microprocessor compares the voltage level detected by said voltage detection device to a predetermined reference voltage value and then drives said power switching module to switch on the connection between said solar cell set and said idle power supply module and to switch off the connection between said rechargeable battery set and said idle power supply module for enabling said idle power supply module to provide battery power supply from said solar cell set to said sleep/wakeup switch and said recognition system when the voltage level detected by said voltage detection device surpasses said predetermined reference voltage value and drives said charging control module to charge said rechargeable battery set with the battery power supply from said solar cell set; said microprocessor controls said power switching module to switch off the connection between said solar cell set and said idle power supply module and to switch on the connection between said rechargeable battery set and said idle power supply module for enabling said idle power supply module to provide battery power supply from said rechargeable battery set to said sleep/wakeup switch and said recognition system when the voltage level detected by said voltage detection device is below said predetermined reference voltage value.

11. The power-saving solar power supply system as claimed in claim 10, wherein said reference voltage value is 3.6V.

12. The power-saving solar power supply system as claimed in claim 10, wherein said reference voltage value is within 2.7V˜3.6V.
